(19) United States
(12) Patent Application Publication
(10) Pub. No.: US 2019/0332370 A1
(43) Pub. Date: Oct. 31, 2019

(54) STORAGE RESERVE IN A FILE SYSTEM

(71) Applicant: Microsoft Technology Licensing, LLC, Redmond, WA (US)

(72) Inventors: Neal Robert CHRISTIANSEN, Bellevue, WA (US); Craig Ashley BARKHOUSE, Duvall, WA (US); Ping LONG, Bellevue, WA (US); Ravisankar V. PUDIPEDDI, Bellevue, WA (US)

(21) Appl. No.: 15/966,530

(22) Filed: Apr. 30, 2018

(51) Int. Cl. G06F 8/65; G06F 3/06; G06F 8/61; G06F 9/54

(52) U.S. Cl. CPC G06F 8/65; G06F 3/0607; G06F 3/0631; G06F 9/544; G06F 8/61; G06F 9/546; G06F 3/0673

(57) ABSTRACT

In a computing device, a first amount of system storage of a computing device is reserved for system update tasks. The first amount is indicated as reserved for system updates and unavailable for access by user applications. The first amount of system storage is then used for installing one or more system updates.

### BACKGROUND

In computing systems, memory is used to store programs and data that are part of a working set of one or more tasks being performed by the system. Operating systems, applications, and other software are frequently updated to provide improved features, fix bugs, and improve the security of a computing device by protecting against new malware threats.

Software updates may be installed by running update programs from media such as a CD-ROM. Updates can also be downloaded via the Internet. Many applications include an automatic update feature that checks for updated versions and download/install the updates, typically with user permissions.

Operating systems may also have an update feature that will download and install new versions and patches to the operating system. In a typical update, various files and data may be downloaded, and the process may involve additional files and data being downloaded as the update process continues. Once the update is completed and the updates are installed, the updated software may be loaded for execution, and the files and data that were used for the update may be deleted.

It is with respect to these and other considerations that the disclosure made herein is presented.

### SUMMARY

In order for a software update to be installed, the necessary software and data must be loaded into available space on the device that is running the software. However, in many cases the device may not have sufficient space to load the necessary software and data. For example, the device may already be loaded with applications and media files that have taken up the available space on the device, as many users often fill their available storage space with music and video files and various applications. This can especially be a problem on smaller devices such as tablets and smartphones that typically have less storage capacity.

When there is insufficient space on the device for such update operations, the necessary software and data may not be able to be loaded. In other situations where storage space is low, the necessary software and data may load, but as the update process proceeds and further space is needed, the update process may fail as the available space runs out. This can happen at multiple points in the update as more files are downloaded and as more processes are invoked. When the update fails, the system must revert to the previous version of the software. Furthermore, the user must find a way to clear up space on the device if the update is to be installed. This may take valuable time and prevent the user from using the device until the system can be restored to its previous state. Furthermore, the failure to update the software may result in the device not having the latest version of the software and thus not having the latest features. If the updated software includes updates that are important to security, then the device may be more susceptible to threats.

An objective of the present disclosure is to provide a way for a system to ensure that software update processes have sufficient available storage space to reliably execute software update processes and install the desired updates. Methods and systems are disclosed to provide a way to reserve space for update operations that is guaranteed.

In one embodiment, a storage reserve is created that sets aside or reserves a specified amount of on-device storage that is available for installation of system updates. Typically, system updates require some amount of disk or other persistent storage on the device. The storage reserve provides a guarantee that the specified amount of storage will be unallocated and available for the update process, when needed.

In one embodiment, the storage reserve may be created by generating a file with allocated space that is sufficient for system update operations. The amount of space in the reservation may depend on various factors such as the type of device, the type of operating system, and the scope of the update. In one example, 2 Gb of space may be allocated to a file, which may be referred to as a “dummy file”. When space is needed for a software update process, the dummy file may be deleted and the freed space may be used by the update process. When the software update process is completed, the dummy file may be generated again so that the space is reserved for future software update processes.

In another embodiment, the storage reserve may be implemented using a quota mechanism where a quota is associated with each user that defines a maximum space allowed for the user. The OS or file system may manage all quotas issued by the system such that the total usage based on the quotas will provide sufficient space for the software update processes. In this embodiment, limits are placed on the users of the system rather than establishing an explicit reservation of the desired storage space for updates.

In one embodiment, a storage reserve may be created by generating a separate partition on the storage volume. For example, a separate storage drive may be instantiated in addition to any storage drives that may be available on the system. The drives may be configured with different sizes, for example the drive reserved for the storage reserve can be 2 Gb, and the drive for general use may include the available system storage space not including the 2 Gb for the storage reserve. Additionally, the drive allocated for the storage reserve may be hidden from view to the user in some embodiments. For example, the drive allocated for the storage reserve may not be visible to the user, or the drive may be visible but the amount of storage in the drive may not be included in the available user storage.

In one embodiment, a virtual disk may be created (e.g., a virtual hard disk (VHD)) that may be used as the storage reserve. The virtual disk may be mounted by the system and used as guaranteed storage for system update operations. In some cases, the use of a virtual disk or a separate partition may incur additional system overhead such as a separate file system. Furthermore, it would be advantageous if the size and other attributes of the storage reserve can be modified during runtime, for example if the reserved space is insufficient. It would also be advantageous to avoid the additional overhead of duplicating resources when multiple storage structures are instantiated.

In an embodiment, a specified amount of storage space may be reserved for the storage reserve using a single file system. The amount of storage space for the storage reserve may be configured so that the amount of storage is inaccessible by other applications or to the user. For example, the reserved amount of storage may be subtracted from the total available space made available and indicated to users and applications. The reserved amount of storage is guaranteed by ensuring that the reserved amount is not allowed to be allocated for other purposes. However, the reserved amount of storage need not be tied to a specific physical or logical location, and does not need to be contiguous.

In some embodiments, the size of the storage reserve may be configurable. For example, the size may be requested via an application programming interface (API) that is accessible to authorized users. Authorized users may also use the API to submit a request to change the size dynamically. Once established, the reserved space for the storage reserve may be fixed until the size is changed via the API.

In one embodiment, different types of storage reserves may be implemented for different priorities and uses. A first type of storage reserve may be for predetermined purposes and may be fixed so that the space is not available for any other use. In an example, the predetermined purposes may include operating system updates or updates installed by a predetermined installer function. In one embodiment, this type of reserved space may be referred to as a “hard” storage reserve. In another embodiment, a second type of storage reserve may be defined. This second type can be reconfigurable and may be used for overflow if there is insufficient space in the first storage reserve or the hard storage reserve. Additionally, the second type of storage reserve may be used for certain predetermined purposes but is not guaranteed in that higher priority tasks may be allowed to use this second type of storage reserve. In one embodiment, this type of reserved space may be referred to as a “soft” storage reserve.

For example, this second type of storage reserve may be used for temporary files (e.g., application data that can be reconstituted at a later time, data that doesn't require user consent to be removed, data that isn't consider data loss, etc.). The second type of storage reserve is otherwise usable by the operating system or installer function for updates as well as other uses. If the temporary files are deleted, then the space in this second type of reserved space occupied by the deleted files will become free and available. However, the user will not have access to the soft storage reserve for general use. It should be noted that more types of storage reserve may be implemented. For illustrative purposes, two example types of storage reserve will be described.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter or a sequence of letters to refer to each individual item. Generic references to the items may use the specific reference number without the sequence of letters.

FIG. 1 an example computer architecture for a computer capable of implemented a storage reserve as described herein.

FIG. 2 illustrates an example of a storage reserve in one embodiment.

FIG. 3 illustrates an example of a storage reserve in one embodiment.

FIG. 4 illustrates an example of a storage reserve in one embodiment.

FIG. 5 illustrates an example of a storage reserve in one embodiment.

FIG. 6 is a flow diagram of an illustrative process for storage reserves in accordance with the present disclosure.

FIG. 7 is a flow diagram of an illustrative process for storage reserves in accordance with the present disclosure.

FIG. 8 is a flow diagram of an illustrative process for storage reserves in accordance with the present disclosure.

FIG. 9 illustrates an example data structure in accordance with the present disclosure.

### DETAILED DESCRIPTION

The following Detailed Description describes methods and systems for providing a way to reserve storage space for system update operations that is guaranteed. In particular, the disclosure describes a way to guarantee that the filing system of a computing device maintains sufficient free space to load software and data that are necessary for updating system software and other functions.

A file system typically controls how data is stored and retrieved from a storage device. For example, a file system may enable data to be stored in files, which are located in a directory structure. The file system tracks files and directories with metadata, which is also stored on the underlying storage device. Other types of metadata ensure integrity of the file system in the event of an unexpected error, provide for recovery of lost data, improve performance by enabling optimizations, and the like.

As used herein, “volume” refers to a logical storage partition defined by the file system.

As used herein, “metadata” refers data stored by the file system used to implement file system functionality. This is in contrast to user data, which stores data on behalf of users and applications. There are different types of metadata, e.g. system metadata and user metadata. System metadata refers to information kept by the file system to facilitate basic operations, including data allocation, ensuring system integrity, etc. User metadata refers to metadata that tracks file names, directory structures, and other user generated information.

As used herein, “user data” refers to content stored by the storage device for a user or an application. User data is typically stored in a file.

As used herein, “storage reserve” refers to a portion of available storage that is reserved for predetermined purposes, as further disclosed herein.

As used herein, “storage reserve area” is a use case of the storage reserve, or an instance of such that has been defined on a volume.

As used herein, a “storage reserve ID” is a predefined unique value that identifies a storage reserve area, and which can also be assigned to files and directories thereby associating them with a given storage reserve area.

As used herein, a “hard reserve” or a “hard storage reserve” is a storage reserve area used to guarantee that systems have a certain minimum amount of disk space required for predetermined purposes.

As used herein, a “soft reserve” or a “soft storage reserve” is a storage reserve area used to provide additional storage space that may be needed at runtime.

In one embodiment, a storage reserve may be created by generating a file with allocated space that is sufficient for system update operations. The amount of space in the reservation may depend on various factors such as the type of device and the type of operating system. In one example, 2 Gb of space may be allocated to a file, which may be referred to as a “dummy file”. When space is needed for a software update process, the dummy file may be deleted and the freed space may be used by the update process. When the software update process is completed, the dummy file may be generated again so that the space is reserved for future software update processes.

In an embodiment, the storage reserve may be implemented using a quota mechanism where a quota is associated with each user that defines a maximum space allowed for the user. The OS or file system may manage all quotas issued by the system such that the total usage based on the quotas will provide sufficient space for the software update processes. In this embodiment there is not an explicit allocation of the desired storage allocation for updates.

In one embodiment, a storage reserve may be created by generating a separate partition. For example, a separate storage drive may be instantiated so that two storage drives may be available on the system. The drives may be configured with different sizes, for example the drive reserved for the storage reserve can be 2 Gb, and the drive for general use may include the available system storage space not including the 2 Gb for the storage reserve. Additionally, the drive allocated for the storage reserve may be hidden from view by the user in some embodiments. For example, the drive allocated for the storage reserve may not be visible to the user, or the drive may be visible but the amount of storage in the drive may not be included in the available user storage.

In one embodiment, a virtual disk may be created e.g., (a virtual hard disk (VHD)) that may be used as the storage reserve. The virtual disk may be mounted by the system and used as guaranteed storage for system update operations.

In some cases, the use of a virtual disk or a separate partition may incur additional system overhead. It would be advantageous if the storage reserve does not incur the additional overhead costs of some of these mechanisms. Furthermore, it would be advantageous if more space can be made available for the storage reserve in case the reserved space is insufficient. Furthermore, it would also be advantageous to avoid the additional overhead of duplicating file system resources if multiple storage structures are instantiated.

In an embodiment, a specified amount of storage space may be reserved for the storage reserve, using a single file system. The amount of storage space for the storage reserve may be configured so that the amount of storage is inaccessible by other applications or to the user. For example, the amount of storage may be subtracted from the total available space made available and indicated to the users and applications. The amount of storage need not be tied to a specific location. The amount of storage is guaranteed by ensuring that it is not allowed to be allocated for other purposes. However, the actual locations for the storage reserve need not be in any particular physical location, and do not need to be contiguous.

In some embodiments, the size of the storage reserve may be configurable. For example, the size may be requested via an application programming interface (API) that is accessible to authorized users. Authorized users may use the API to submit a request to change the size dynamically. Once established, the reserved space for the storage reserve may be fixed until the size is changed via the API.

In one embodiment, different types of storage reserves may be implemented for different uses. A first type of storage reserve may be for predetermined purposes and may be fixed so that the space is not available for any other use. In an example, the predetermined purposes may include operating system updates or updates installed by a predetermined installer. In one embodiment, this type of reserved space may be referred to as “hard”. In another embodiment, a second type of storage reserve may be defined. This second type can be reconfigurable and may be used for overflow if there is insufficient space in the first storage reserve or the hard storage reserve. Additionally, the second type of storage reserve may be used for certain predetermined purposes but is not guaranteed in that higher priority tasks may be allowed to use this second type of storage reserve. In one embodiment, this type of reserved space may be referred to as “soft”.

For example, this second type of storage reserve may be used for temporary files (e.g., application data that can be reconstituted at a later time, data that doesn't need user consent to be removed, data that isn't consider data loss, etc.). The second type of storage reserve is otherwise usable by the operating system or installer function for updates as well as other uses. If the temporary files are deleted, then the space in this second type of reserved space occupied by the deleted files will be free and available. However, the user does not have access to this reserved space. It should be noted that more types of storage reserve may be implemented. For illustrative purposes, two example types of storage reserve will be described.

In order to guarantee that a storage reserve can meet the desired size for the reserve, the computing system may maintain information on how much space in the storage reserve is currently used. The system may then determine how much space needs to be set aside in order to guarantee that the desired size can be met. In one embodiment, the used space may be calculated when the system is booted by searching files and adding up the space used in each storage reserve area. In another embodiment a value may be maintained and incremental changes may be accumulated as individual files are added or removed from the storage reserve area. In one example, a RESERVE SPACE USED value and a RESERVE SIZE value may be maintained. The amount of space that should then be set aside to guarantee that the total reserve space is available may be calculated as RESERVE SIZE—RESERVE SPACE USED). In the case where the reserve area has overflowed (RESERVE SPACE USED>RESERVE SIZE), then there is no longer a space guarantee and the file system will not set aside any space.

The space allocations for the two types of storage reserve can be different. The space allocations may also vary depending on the type of device (tablet, smartphone), type of system (64 bit or 32 bit), operating system version, the size of the device's storage space, etc.

In an embodiment, files and directories can be marked for or assigned to one of the reserved storage reserves. The file or directory may inherit the attributes of the type of storage reserve that it is associated with. Additionally, if a directory is marked with a storage reserve, then a file that is created in that directory may inherit the attributes of that storage reserve. In an embodiment, a file can be created with a zero-length allocation and marked for a storage reserve. The file may automatically inherit the attributes of the storage reserve, and when the file is extended the extended space will maintain the same attributes. Alternatively, the file may be created in the general storage area. The file may then be moved to the storage reserve and the file may then inherit the attributes of the storage reserve. In some embodiments, where multiple file names point to the same file, inheritance may be provided based on the most recent target directory (e.g., the last designation prevails).

In some embodiments, inheritance may be enabled for multiple files or levels of files where a directory is move or assigned to a storage reserve. In other words, when a directory is moved from one area to another where the destination changes the storage reserve type or moves from a storage reserve to the general area, then all files within the directory may inherit the attributes of the destination. An override may be provided so that inheritance is not attributed to subfolders in certain cases, such as when the directory structure is large and the time to extend the attributes to all subfolders and their contents would be excessive.

In some embodiments, spillover from one storage reserve type to another may be allowed. Additionally, there may be spillover from one of the storage reserve types to the general storage area that is not allocated to one of the storage reserve types. Whether the spillover is allowed may be determined based on the storage reserve types. For example, the hard storage reserve may be characterized in that its reserved space is guaranteed and there is no spillover allowed into this area. Therefore, any requests to spillover to the space reservation for a hard storage reserve may be denied.

A soft storage reserve may be characterized in that space is reserved for the soft storage reserve but this reserved space is not guaranteed because the hard storage reserve is allowed to spillover to the soft storage reserve. In this case, even if an operation requires more space than the amount available in the hard storage reserve, the operation may be successful if the soft storage reserve has sufficient space to take the spillover request. As files are generated in the hard storage reserve, they may be transferred to the general storage area once the files are ready to go live. This will also free up space for future use in the hard storage reserve.

Requests to reserve one or more reservation types may be generated by a process executing in the OS, an installer function, or from an authorized user via the API. In one embodiment, creation and management of storage reserves may only be available to the operating system of the computing device, for example via the file system. In some embodiments, applications and other users may make requests and decide how to use the mechanism. The operating system may grant or deny requests based on whether the request pertains to a hard storage reserve or a soft storage reserve, and based on current status of free and allocated space.

In some embodiments, applications may be provided access to one or more of the storage reserve types. For example, applications that need to perform updates may send a request via the API for access to one of the storage reserves. In an embodiment, when requests for use of the storage reserves are in conflict, then the OS can prioritize the requests based on a predetermined priority, the current free/allocated space, and other factors.

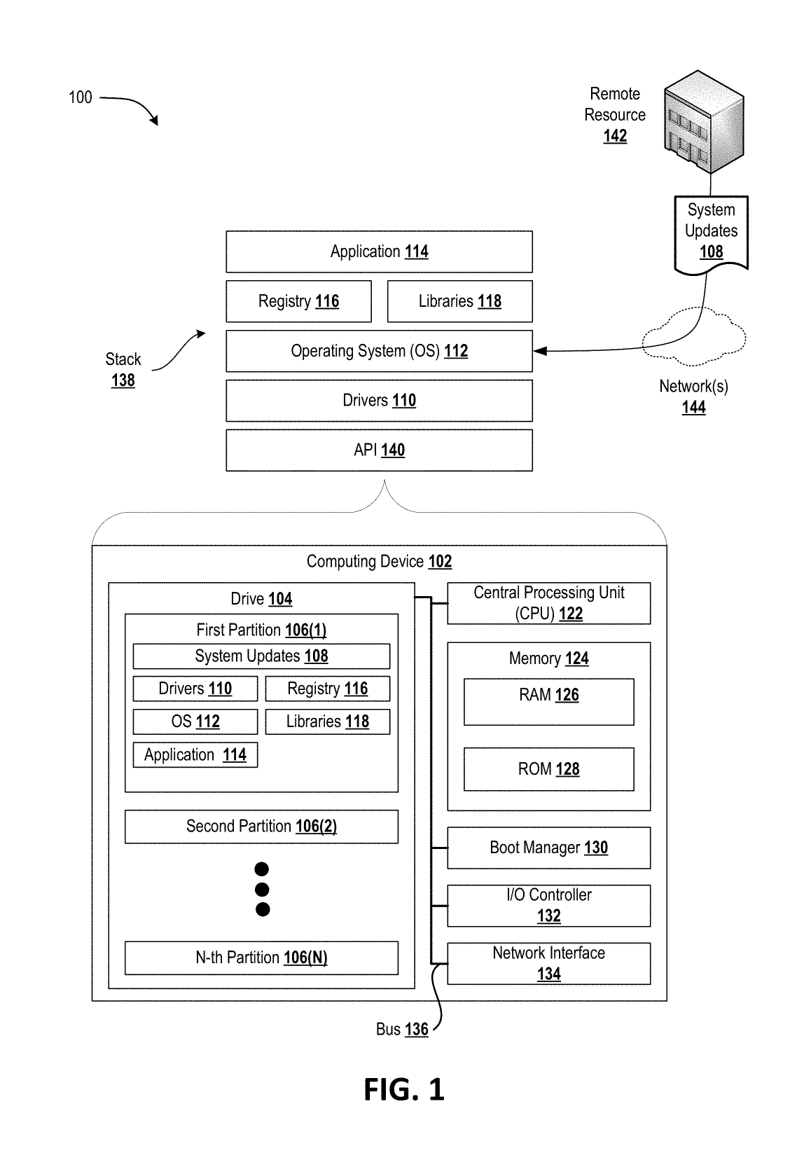

Turning now to FIG. 1, illustrated is an example computing architecture 100 that receives system updates 108 on a computing device 102. The computing device 102 is configured to create one or more storage reserves to accommodate the system updates 108. For example, updates may be received to update one or more system components. Example system components include, but are not limited to, drivers 110, an operating system (OS) 112, an application 114, a registry 116, and/or libraries 118.

As illustrated in FIG. 1, the computing device 102 may include one or more drive(s) 104 (hereinafter referred to as the “drive”) having computer-readable media that provides nonvolatile storage for the computing device 102. Example drives include, but are not limited to, SATA-type solid-state hard drives, SATA-type hard disks, PATA-type solid-state hard drives, PATA-type hard disks, and/or any other drive-type suitable for providing non-volatile computer-readable media to a computing device. The drive 104 may include partitions 106 for logically separating one or more system components and/or data objects. In the illustrated example, the drive 104 is separated into a first partition 106(1), a second partition 106(2), and an N-th partition 106(N). In some embodiments, at least one of the partitions 106 stores drivers 110 and an operating system (OS) 112 to enable a boot manager 130 to initiate the drivers 110 and to load the OS 112 into a memory 124. In the illustrated example, the memory 124 includes a random-access memory (“RAM”) 126 and a read-only memory (“ROM”) 128. As further illustrated, the computing device 102 includes a central processing unit (“CPU”) 122 that is connected, via a bus 136, to the drive 104, the memory 124, and the boot manager 130. In some embodiments, the bus 136 further connects an input/output (I/O) controller 132 and/or a network interface 134.

It can be appreciated that the system components described herein (e.g., the drivers 110, the OS 112, and/or the application 114) may, when loaded into the CPU 122 and executed, transform the CPU 122 and the overall computing device 102 from a general-purpose computing system into a special-purpose computing system customized to facilitate the functionality presented herein. The CPU 122 may be constructed from any number of transistors or other discrete circuit elements, which may individually or collectively assume any number of states. More specifically, the CPU 122 may operate as a finite-state machine, in response to executable instructions contained within the software modules disclosed herein. These computer-executable instructions may transform the CPU 122 by specifying how the CPU 122 transitions between states, thereby transforming the transistors or other discrete hardware elements constituting the CPU 122.

The drive 104 and associated computer-readable media provide non-volatile storage for the computing device 102. Although the description of computer-readable media contained herein refers to a mass storage device, such as a solid-state drive and/or a hard disk, it should be appreciated by those skilled in the art that computer-readable media can be any available computer storage media or communication media that can be accessed by a computing architecture such as, for example, the computing architecture 100. Communication media includes computer-readable instructions, data structures, program modules, and/or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above are also included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing device 102. For purposes of the claims, the phrase “computer storage medium,” “computer-readable storage medium,” and variations thereof, does not include waves, signals, and/or other transitory and/or intangible communication media, per se.

The boot manager 130 may access the OS 112 from the drive 104 (or a partition thereof) and may load the OS 112 into the memory 124 for runtime execution by the computing device 102 (e.g., by invoking an OS boot loader). The I/O controller 132 may receive and process input from a number of other devices, including a keyboard, mouse, or electronic stylus (not shown in FIG. 1). Similarly, the I/O controller 132 may provide output to a display screen, a printer, or other type of output device (also not shown in FIG. 1). The network interface 134 may enable the computing device 102 to connect to one or more network(s) 144 such as a local area network (LAN), a wide area network (WAN), a wireless local area network (WLAN), or any other suitable network for passing information between the computing device 102 and a remote resource 142.

As described above, the drive 104 may include multiple partitions 106 for logically separating one or more system components and/or data objects. In the illustrated example, the drive 104 includes the first partition 106(1) which stores instances of the drivers 110, the OS 112, the application 114, the registry 116, and the libraries 118. The drivers 110 may include one or more programs for controlling one or more devices that are communicatively coupled to the computing device 102 such as, for example, printers, displays, cameras, soundcards, network cards, computer storage devices, etc. The OS 112 may be any suitable system software for managing computer hardware and/or software resources and for providing services to the application 114 and/or other applications (not shown). An example OS 112 may include, but is not limited to, various versions of MICROSOFT WINDOWS (e.g., WINDOWS 8.1 or 10, WINDOWS EMBEDDED STANDARD 7, etc.), Mac OS X, iOS, etc.

The application 114 may be a computer program that is configured to be run by the OS 112 to perform one or more coordinated functions, tasks, activities. The registry 116 may correspond to a database containing information usable to boot and/or configure the OS 112, system-wide software settings that control the operation of the OS 112, security databases, and/or user specific configuration settings. The registry 116 may further contain information associated with in-memory volatile data such as, for example, a current hardware state of the OS 112 (e.g., which drivers are currently loaded and in use by the OS 112).

The libraries 118 may include a collection of non-volatile resources that are usable (e.g., callable) by the application 114 and/or other applications (not shown). Example resources include, but are not limited to, pre-written code and/or subroutines, configuration data, and/or classes (e.g., extensible program-code-templates for creating objects of various types). In various implementations, the libraries 118 may enable the application 114 to call upon various system services provided by the OS 112. For example, the libraries 118 may include one or more subsystem Dynamic Link Libraries (DLLs) configured for implementing and/or exposing Application Programming Interface (API) functionalities of the OS 112 to the application 114.

In order to install the system updates 108, the computing device 102 may be configured to enter an update installation mode during which the system updates 108 can be saved and/or installed onto an available area in storage. In this illustrated example, the OS 112 determines that the system updates 108 have become available from a remote resource 142 via the one or more network(s) 144. For example, the system updates 108 may be an Over-the-Air (OTA) update associated with one or more of the drivers 110, the OS 112 and/or the application 114. Upon determining that the system updates 108 are available, the OS 112 may respond by allowing the files and data for the update to be loaded to one of the partitions 106 in an area that is available in accordance with the storage reserve.

In one embodiment, APIs 140 may be implemented for managing storage reserve areas applicable to one or more volumes. The managing functionality may include defining, querying, and other functions. In an embodiment, at least one API may be configured to define or update one or more storage reserves, including associated flags and the configured size. If an existing storage reserve area is defined, then that area may be updated accordingly. Otherwise, a new area can be defined. The requested size may be rounded to match the storage structure of the computing device, e.g., rounded up to the next cluster size multiple. In some embodiments, a size of 0 may be allowed. A storage reserve with a 0 size reservation will not have a reservation applied to the area but files and directories can be assigned to the area, in contrast to an area that has never been defined or has been deleted.

In an embodiment, at least one API may be configured to query information about one or more reserve areas on a volume. The returned information may include the definition information such as flags and configured size, and current state information such as the amount of space used. In some embodiments, the API may return for all defined areas on the volume.

In an embodiment, at least one API may be configured to send a request to the file system to recalculate the space used against one or more storage reserve areas on a volume, by locating all files and directories assigned to the reserve area(s) and adding up their total allocation. The API may be configured to enumerate all files and directories on a volume that are assigned to storage reserve areas. Individual files and directories may be assigned to reserve areas, identified by their reserve area ID. Individual files and directories may also be removed from its reserve area. The operation may fail due to lack of available disk space since such an operation may move a file from the reserved area to the general area, and the general area may not have sufficient space for the file.

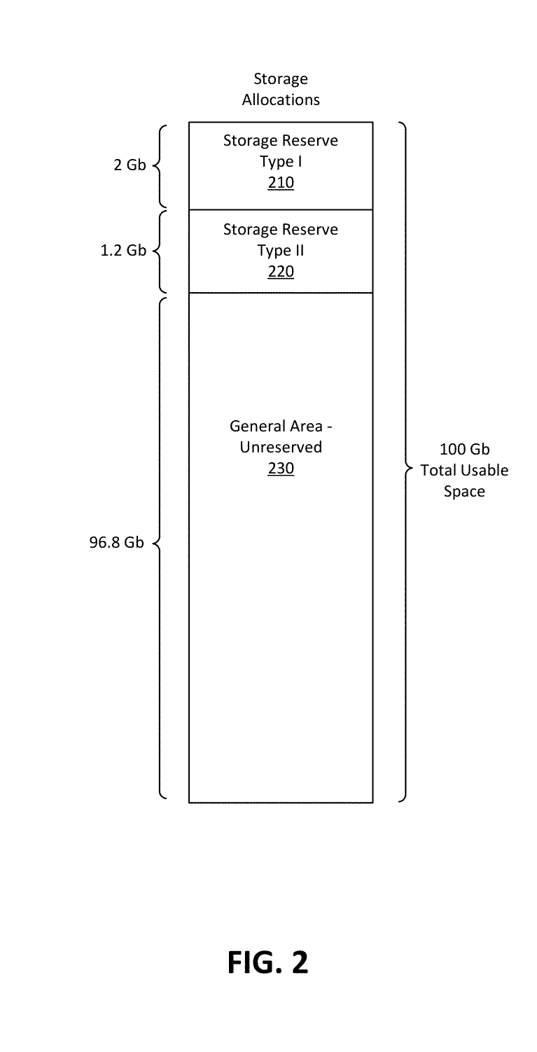

FIG. 2 illustrates different types of storage reserves that are implemented for different uses. Storage reserve 210 illustrates a first type of storage reserve that may be for predetermined purposes and may be fixed so that the space is not available for any other use. Storage reserve 220 illustrates a second type of storage reserve that can be reconfigurable and may be used for overflow if there is insufficient space in the first storage reserve or the hard storage reserve. Additionally, the second type of storage reserve may be used for certain predetermined purposes but is not guaranteed in that higher priority tasks may be allowed to use this second type of storage reserve.

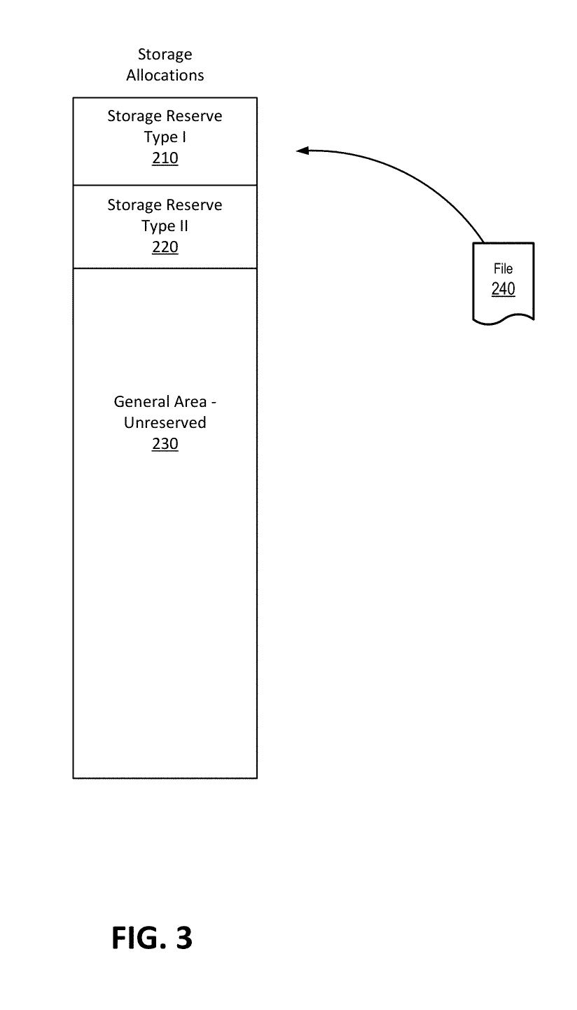

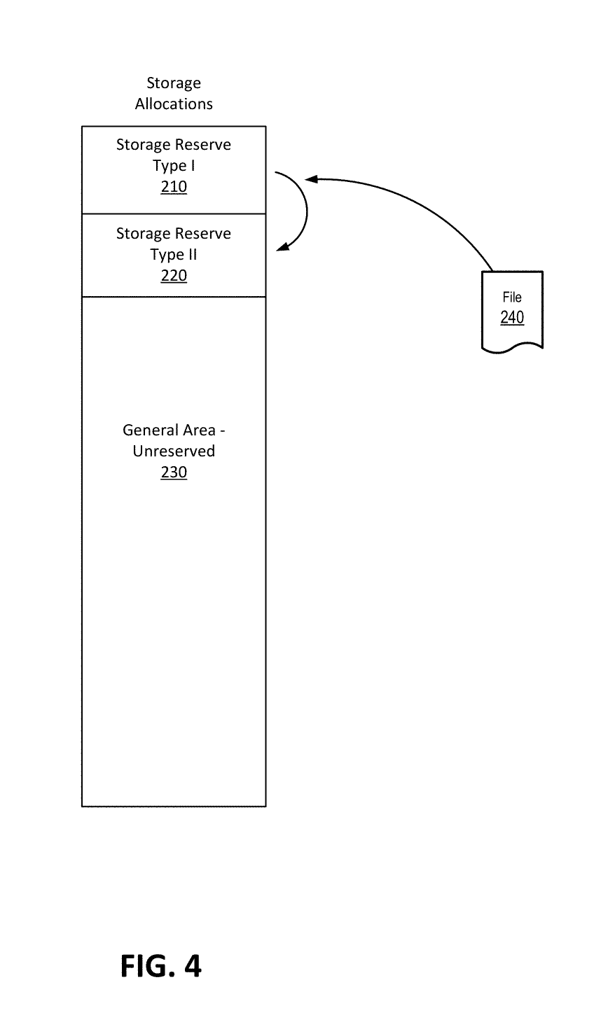

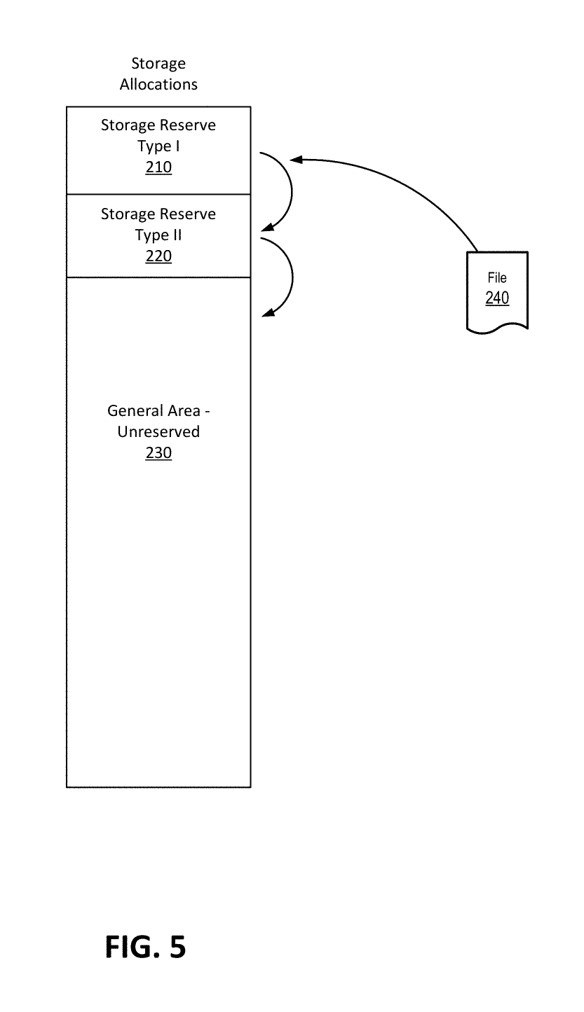

In an embodiment, newly created files and directories may automatically inherit the storage reserve ID and other properties of their parent. As illustrated in FIG. 3, a file 240 that is allocated to storage reserve type 1 will inherit the properties of this type. The Files and directories that are renamed to a new parent (e.g., moved) may automatically inherit the storage reserve ID of their new parent. As illustrated in FIG. 4, when file 240 is moved to storage reserve type 2 will inherit the properties of this type. Since a rename can change the storage reserve ID of the file or directory, the rename operation may fail if there is insufficient space in the general area. For example, if a file is moved from a soft storage reserve into the general area 230 as shown in FIG. 5, and the general area 230 is at capacity, then the move may fail.

When a non-empty directory is moved to a new parent, in addition to inheritance on the directory being moved, in some embodiments, if the new storage reserve ID is different, the inheritance may be recursively applied to all contents in the directory. Renames may therefore take an unexpectedly long time. To provide for cases where rename inheritance is not desired, an opt-out flag may be provided.

When hard linking a file to a new parent, the storage reserve ID may automatically be changed to that of the new parent, thus effecting a “last link wins” policy. In some embodiments, an opt-out flag may be provided if hard link inheritance is not desired.

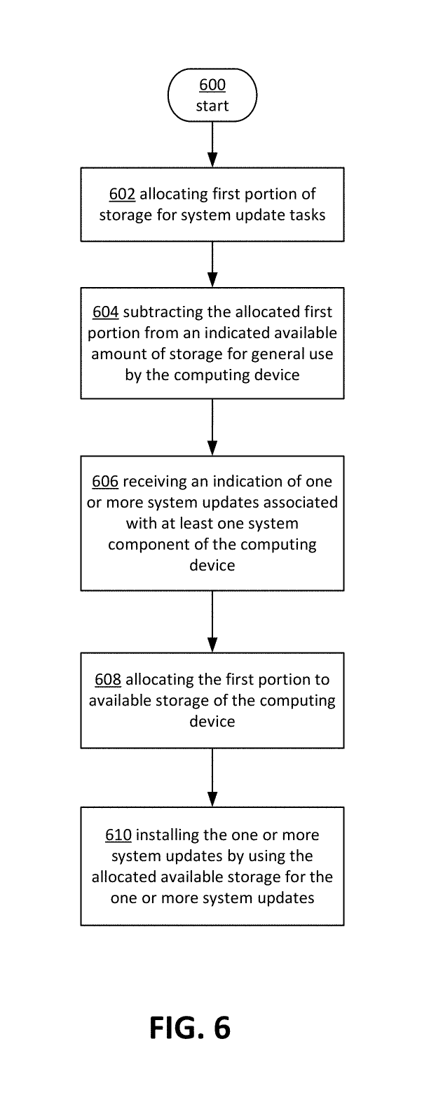

Turning now to FIG. 6, illustrated is an example operational procedure for facilitating updates in accordance with the present disclosure. In an embodiment, the example operational procedure may implement a method executing on one or more computing devices. Such an operational procedure may provide for implementing a storage reserve as described herein and as illustrated in FIGS. 1-5.

Referring to FIG. 6, operation 602 illustrates allocating a first portion of a total amount of storage of the computing device for system update tasks. Operation 602 may be followed by operation 604. Operation 604 illustrates subtracting the allocated first portion from an indicated available amount of storage for general use by the computing device.

Operation 604 may be followed by operation 606. Operation 606 illustrates receiving an indication of one or more system updates associated with at least one system component of the computing device.

Operation 606 may be followed by operation 608. Operation 608 illustrates based at least in part on the indication, allocating the first portion to available storage of the computing device. Operation 608 may be followed by operation 610. In an embodiment, the allocated first portion of the total amount of storage is a number that is a guaranteed amount of storage that is reserved. The free and allocated portions of the total amount of storage may be managed so that the total amount of the storage will at least include space equivalent to the allocated first portion of the total amount of storage. When the allocated first portion is needed for system update tasks, the space may be allocated from the available storage so that the system update tasks may be performed

Operation 610 illustrates based at least in part on the indication, installing the one or more system updates with respect to the at least one system component by using the allocated available storage for the one or more system updates.

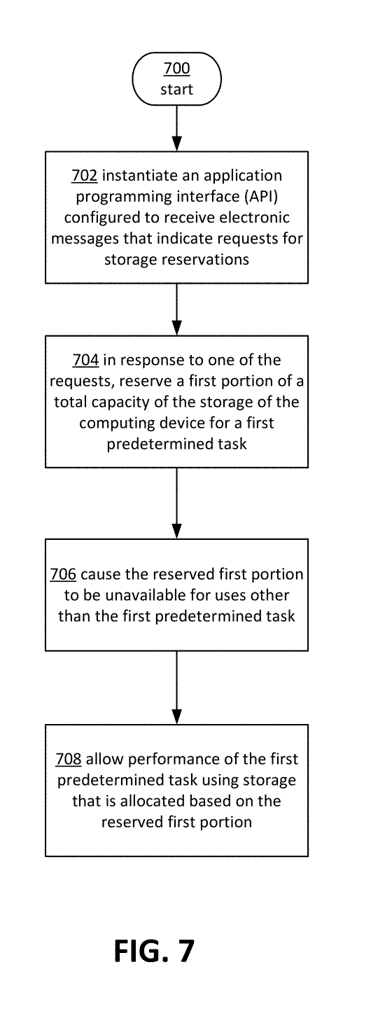

Turning now to FIG. 7, illustrated is an example operational procedure for facilitating updates in accordance with the present disclosure. Operation 702 illustrates instantiating an application programming interface (API) configured to receive electronic messages that indicate requests for storage reservations. Operation 702 may be followed by operation 704. Operation 704 illustrates in response to one of the requests, reserving a first portion of a total capacity of the storage of the computing device for system update tasks.

Operation 704 may be followed by operation 706. Operation 706 illustrates causing the reserved first portion to be unavailable for uses other than the system update tasks.

Operation 706 may be followed by operation 708. Operation 708 illustrates allowing installation of one or more system updates using storage that is allocated based on the reserved first portion. In an embodiment, the reserved first portion of the total capacity of the storage is a number that is a guaranteed amount of storage that is reserved. The free and allocated portions of the storage capacity may be managed so that the total capacity of the storage will at least include space equivalent to the reserved first portion of the total capacity. When the reserved first portion is needed for system update tasks, the space may be allocated from the available capacity so that the system update tasks may be performed.

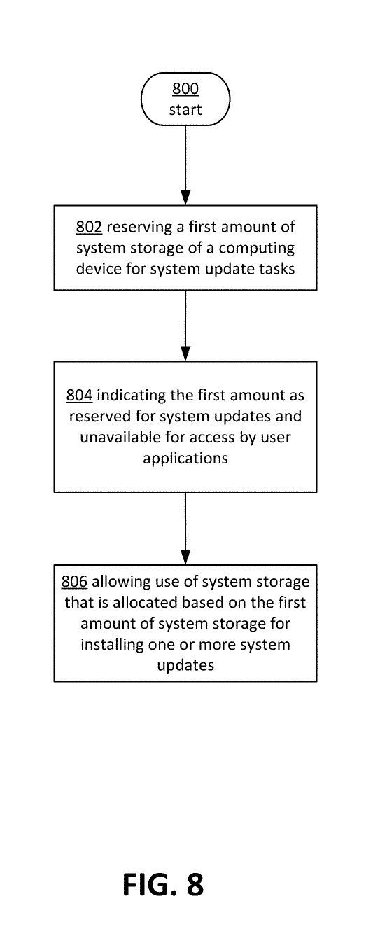

Turning now to FIG. 8, illustrated is an example operational procedure for facilitating updates in accordance with the present disclosure. Operation 802 illustrates reserving a first amount of system storage of a computing device for system update tasks. Operation 802 may be followed by operation 804. Operation 804 illustrates indicating the first amount as reserved for system updates and unavailable for access by user applications.

Operation 804 may be followed by operation 806. Operation 806 illustrates allowing use of system storage that is allocated based on the first amount of system storage for installing one or more system updates. In an embodiment, the first reserved amount of storage is a number that is a guaranteed amount of storage that is reserved. The free and allocated portions of the system storage may be managed so that the total free space will at least include space equivalent to the first reserved amount of storage. When the reserved space is needed for system update tasks, the space may be allocated from the available storage so that the system update tasks may be performed.

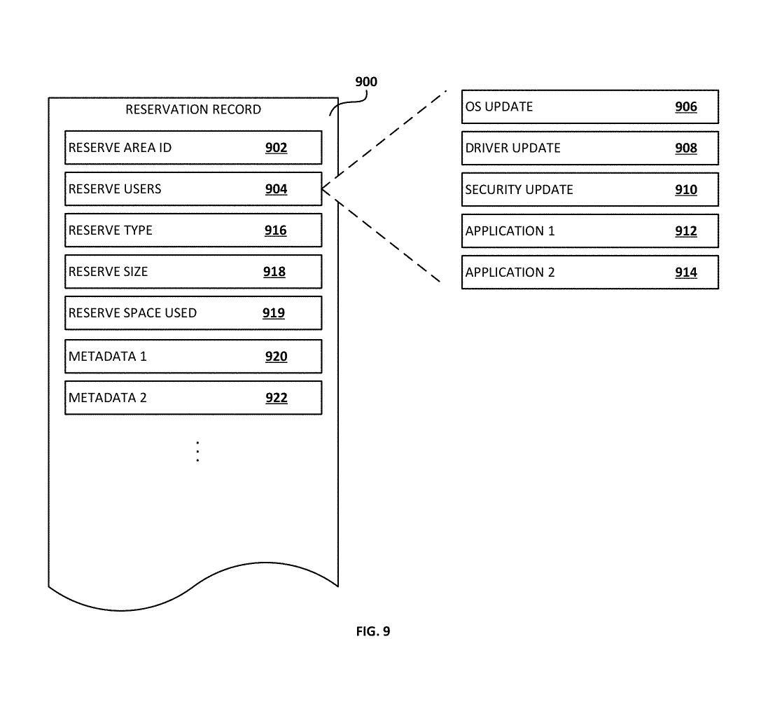

FIG. 9 is a data structure diagram showing a number of data elements stored in a reservation record 900 storing metadata for a storage reserve. It will be appreciated by one skilled in the art that the data structure shown in the figure may represent a data file, a database table, an object stored in a computer storage, a programmatic structure or any other data container commonly known in the art. Each data element included in the data structure may represent one or more fields in a data file, one or more columns of a database table, one or more attributes of an object, one or more variables of a programmatic structure or any other unit of data of a data structure commonly known in the art.

Each reservation record 900 may contain a reservation ID 902 identifying the reservation for whom the reservation record 900 is created. According to one embodiment, each reservation record 900 may also contain a reservation users field 904 identifying the various functions or users who are allowed to use the storage reserve. In one example, the reservation users field 904 may include OS update 906, driver update 908, security update 910, application 1 912, application 2 914, and the like. The reservation record 900 may also contain reservation type 916 indicating, for example, if the reservation is hard or soft.

The reservation record 900 may also contain information regarding a reservation size 918. The reservation record 900 may contain a reservation space used field 919 indicating, for example, the total space used by all files associated with the storage reserve. Based on the reservation space used 919, it may be determined how much space remains in the associated storage reserve, and therefore how much space (RESERVE SIZE—RESERVE SPACE USED) the file system needs to set aside in order to honor the guarantee that the reserve area can be filled. The reservation record 900 may further contain information regarding one or more metadata 920 and 922A-920N. It will be appreciated that the reservation record 900 may contain additional data elements beyond those shown in FIG. 9 and described above that are utilized in conjunction with reserve storage areas.

Although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subj ect matter.

### EXAMPLE CLAUSES

Example Clause A, a method for facilitating updates to a computing device, the method comprising:

allocating a first portion of a total amount of storage of the computing device for system update tasks;

subtracting the allocated first portion from an indicated available amount of storage for general use by the computing device;

receiving an indication of one or more system updates associated with at least one system component of the computing device;

based at least in part on the indication, allocating the first portion to available storage of the computing device; and installing the one or more system updates with respect to the at least one system component by using the allocated available storage for the one or more system updates.

Example Clause B, the method of Example Clause A, further comprising allocating a second portion of the total amount of storage of the computing device for use by one or more predetermined tasks.

Example Clause C, the method of any of Example Clauses A through B, wherein the second portion is allowed to be used for system updates if allocated space in the first portion is insufficient.

Example Clause D, the method of any of Example Clauses A through C, wherein said allocation comprises a reservation of an amount of storage space.

Example Clause E, the method of any of Example Clauses A through D, wherein said allocation comprises instantiation of a storage volume.

Example Clause F, the method of any of Example Clauses A through E, wherein said allocation comprises instantiation of a virtual hard disk that is mounted as an additional volume.

Example Clause G, a computing device comprising:

one or more processors; and

a storage in communication with the one or more processors, the storage having computer-readable instructions stored thereupon which, when executed by the one or more processors, cause the computing device to:

instantiate an application programming interface (API) configured to receive electronic messages that indicate requests for storage reservations;

in response to one of the requests, reserve a first portion of a total capacity of storage of the computing device for system update tasks;

cause the reserved first portion to be unavailable for uses other than the system update tasks; and

allow performance of the first predetermined task using storage that is allocated based on the reserved first portion.

Example Clause H, the computing device of Example Clauses G, wherein the requests include a request for an amount of storage capacity.

Example Clause I, the computing device of any of Example Clauses G through H, wherein the first portion is reserved by creating a file and deleting the file when the system update tasks are to be performed.

Example Clause J, the computing device of any of Example Clauses G through I, wherein the first portion is reserved by creating an additional storage volume.

Example Clause K, the computing device of any of Example Clauses G through J, wherein in response to one of the requests, a second portion of a total storage capacity is reserved for a second predetermined task.

Example Clause L, the computing device of any of Example Clauses G through K, wherein files or directories allocated to the first or second portions are assigned attributes associated with the assigned portions.

Example Clause M, the computing device of any of Example Clauses G through L, wherein files or directories moved to the first or second portions inherit attributes associated with the destination portion.

Example Clause N, the computing device of any of Example Clauses G through M, wherein creating a hard link in the first or second portions causes the linked-to file to inherit attributes associated with the parent directory of the hard link.

Example Clause O, the computing device of any of Example Clauses G through N, wherein all files within moved directories inherit attributes associated with the destination portion

Example Clause P, the computing device of any of Example Clauses G through O, further comprising:

based on a user input, inhibiting the inheriting of attributes associated with the destination portion.

Example Clause Q, A method comprising:

reserving a first amount of system storage of a computing device for system update tasks;

indicating the first amount as reserved for system updates and unavailable for access by user applications; and

allowing use of system storage that is allocated based on the first amount of system storage for installing one or more system updates.

Example Clause R, the method of Example Clause Q, further comprising reserving a second amount of system storage for predetermined system tasks, wherein the second amount is unavailable for access by the user applications.

Example Clause S, the method of any of Example Clauses Q through R, wherein the second amount is available for system updates when the first amount is insufficient.

Example Clause T, the method of any of Example Clauses Q through S, wherein general-use system storage is used for system updates when the first and second amounts are insufficient.

While Example Clauses G through N are described above with respect to a computing device, it is also understood in the context of this disclosure that the subject matter of Example Clauses G through N can additionally and/or alternatively be implemented via a method, a system, and/or computer storage media.

1. A method for facilitating updates to a computing device, the method comprising:
configuring storage of a computing device to allocate a first portion of a total amount of the storage of the computing device exclusively for system update tasks;
subtracting the allocated first portion from an indicated available amount of storage for general use by the computing device, wherein the allocated first portion is not available for tasks that are not system update tasks;
receiving an indication that one or more system updates associated with at least one system component of the computing device is available for the computing device;
based at least in part on the indication, allocating the first portion to available storage of the computing device for installing the one or more system updates;
installing the one or more system updates with respect to the at least one system component by using the allocated available storage for the one or more system updates; and
subsequent to installing the one or more system updates, continuing to allocate the first portion of the total amount of the storage of the computing device exclusively for system update tasks.

2. The method of claim 1, further comprising allocating a second portion of the total amount of storage of the computing device for use by one or more predetermined tasks.

3. The method of claim 2, wherein the second portion is allowed to be used for system updates if allocated space in the first portion is insufficient.

4. The method of claim 1, wherein said allocation comprises a reservation of an amount of storage space.

5. The method of claim 1, wherein said allocation comprises instantiation of a storage volume.

6. The method of claim 1, wherein said allocation comprises instantiation of a virtual hard disk that is mounted as an additional volume.

7. A computing device comprising:
one or more processors; and
a storage device in communication with the one or more processors, the storage device having computer-readable instructions stored thereupon which, when executed by the one or more processors, cause the computing device to:
instantiate an application programming interface (API) configured to receive electronic messages that indicate requests for storage reservations;
in response to one of the requests, reserve a first portion of a total storage capacity of the computing device exclusively for a first predetermined task;
cause the reserved first portion to be unavailable for uses other than the first predetermined task; and
allow performance of the first predetermined task using storage that is allocated based on the reserved first portion.

8. The computing device of claim 7, wherein the requests include a request for an amount of storage capacity.

9. The computing device of claim 7, wherein the first portion is reserved by creating a file and deleting the file when the first predetermined task is to be performed.

10. The computing device of claim 7, wherein the first portion is reserved by creating an additional storage volume.

11. The computing device of claim 7, wherein in response to one of the requests, a second portion of a total storage capacity is reserved for a second predetermined task.

12. The computing device of claim 11, wherein files or directories allocated to the first or second portions are assigned attributes associated with the assigned portions.

13. The computing device of claim 12, wherein files or directories moved to the first or second portions inherit attributes associated with the destination.

14. The computing device of claim 12, wherein creating a hard link in the first or second portions causes the linked-to file to inherit attributes associated with a parent directory of the hard link.

15. The computing device of claim 13, wherein all files within moved directories inherit attributes associated with the destination.

16. The computing device of claim 15, further comprising:
based on a user input, inhibiting the inheriting of attributes associated with the destination.

17. A method comprising:
reserving a first amount of system storage of a computing device exclusively for system update tasks;
indicating the first amount as reserved for system updates and unavailable for access by user applications; and
allowing use of system storage that is allocated based on the first amount of system storage for installing one or more system updates.

18. The method of claim 17, further comprising reserving a second amount of system storage for predetermined system tasks, wherein the second amount is unavailable for access by the user applications.

19. The method of claim 18, wherein the second amount is available for system updates when the first amount is insufficient.

20. The method of claim 19, wherein general-use system storage is used for system updates when the first and second amounts are insufficient.
